(19) United States
(12) Patent Application Publication
(10) Pub. No.: US 2008/0314513 A1
(43) Pub. Date: Dec. 25, 2008

(54) Device for imparting a pattern onto the surface of work pieces

(76) Inventors: Achim Gauss, Dornstetten/Hallwangen (DE); Johannes Schmid, Starzach/Wachendorf (DE)

Correspondence Address: BAKER BOTTS L.L.P., 30 ROCKEFELLER PLAZA, 44TH FLOOR, NEW YORK, NY, 10112-4498, US

(21) Appl. No.: 11/765,196

(22) Filed: Jun. 19, 2007

(51) Int. Cl. B32B 38/14

(52) U.S. Cl. 156/277; 156/387

(57) ABSTRACT

The invention concerns a device for imparting a pattern onto a surface of work pieces, which consist preferably at least partially of wood, wood materials, plastics or the like, with a printing unit, a sheet feed unit to feed a sheet-like material along printing unit, so that the sheet-like material can be printed by printing unit, a sheet supply unit for continuous supply of the sheet-like material to the sheet feed unit, an application unit to apply the printed sheet-like material to the surface of the corresponding work piece and a conveyor device, set up to produce a relative movement between the corresponding work pieces and at least the application unit.

### TECHNICAL FIELD

The invention relates to a device for imparting a pattern onto (decorating) the surface of work pieces, which preferably consist at least partially of wood, wood materials, plastics or the like, with a printing unit.

### PRIOR ART

Work pieces of the type just mentioned are widely used, for example, in furniture and interior finishing. To impart a desired appearance to them at low cost the surfaces of the work pieces are increasingly being printed with a printing unit. For example, DE 20 2004 000 622 U1 and WO 02/00449 A1 disclosed devices for imparting a pattern onto the surface of work pieces, in which inkjet printing systems are used to impart a desired pattern to the surface of the work pieces.

This technology works under practical conditions for rectangular, plate-like work pieces. However, it has been found that irregular work pieces, like free-form panels, elongated sections with a free-form cross-section, three-dimensionally curved work pieces, etc., can only be printed with this method with difficulty, since a distorted printing image is produced and the printing head must be continuously adapted to the surface contour.

In addition, the applicant has filed a still unpublished European Patent Application numbered 05009326.9 on the filing date of the present application. It concerns a device and method for imparting a patterns onto the narrow sides of panel-like work pieces, but, among other things, does not disclose a sheet supply unit.

A device with which work pieces can be laminated with a printed film is also known, for example, from DE 101 42 432 C1. However, this device has low variability in terms of attainable patterns, since only films with patterns from a limited supply can be furnished. In addition, a change of the film being laminated is demanding and leads to machine shutdowns.

### DESCRIPTION OF THE INVENTION

It is therefore the task of the invention to provide a device for imparting a pattern onto the surface of work pieces, which also permits simple and variable patterns in irregularly formed work pieces.

This task is solved according to the invention by a device according to Claim 1 and a method for operation of the device according to Claim 17. Particularly advantageous modifications of the invention are given in the dependent claims.

The underlying idea of the invention is to be able to select the pattern of the surface of the work piece as late as possible. For this purpose, it is proposed according to the invention that a device of the type just mentioned also have a sheet feed unit to feed a sheet-like material along the printing unit, so that the sheet-like material can be printed by the printing unit, a sheet supply unit for continuous supply of the sheet-like material to the sheet feed unit and an application unit to apply the printed sheet-like material to the surface of the corresponding work piece.

By printing a sheet-like material instead of the work piece surface, it becomes possible to satisfactorily print even work pieces with complicated geometry, although the present invention is not restricted to this. Moreover, the provision of a printing unit to print the sheet-like material makes it possible for pattern selection to occur only right before application of the sheet-like material, so that extremely high variability of the device according to the invention is produced, so that a continuous surface can be produced with alternating patterns on a single work piece.

Although Claim 1 of the present application is geared toward a device with a sheet supply unit, it must be kept mind that the present invention, in principle, also achieves the aforementioned advantages without the sheet supply unit, and that it is therefore not essential to the invention.

According to a modification of the present invention, it is proposed that the printing unit be arranged, so that the side of the sheet-like material facing away from the work piece is printed. Because of this, work pieces, in which the nature of the sheet-like coating material is covered by the printing and the printing directly faces the viewer can be produced.

According to an alternative embodiment, it is also proposed that the printing unit be arranged, so that the side of the sheet-like material facing the work piece is printed. In this design, several variants are also again conceivable. On the one hand, the sheet-like material can be transparent or at least semi-transparent, so that printing of the sheet-like material is also visible to a viewer after application on a work piece. As an alternative, it is also conceivable that the sheet-like material is only used as a transfer medium and the printing applied to the sheet-like material is transferred to the surface by application of the printed sheet-like material to the corresponding work piece. In this variant, the sheet-like material therefore need not remain on the surface of the work piece, but is used only as a transfer medium. Because of this, a situation can be achieved in which the surface condition, tactile features, etc. of the work piece, are not adversely influenced by the sheet-like material.

The printing unit in the context of the present invention can be configured in a wide variety of ways. With respect to a rapid and high-quality printing process, however, it has proven to be advantageous that, according to a modification of the invention, the printing unit is an inkjet printing unit or a rotary printing unit. The inkjet printing unit can be a drop-on-demand printing unit in which the individual ink drops are ejected, using a piezo element or a thermoelement in reaction to corresponding control signals.

The sheet supply unit can assume different forms, depending on the configuration of the sheet-like material. It has proven to be advantageous that the sheet supply unit has a receptacle for a supply of sheet-like material, which preferably contains a supply of sheet-like material.

Particularly novel and appealing effects can be achieved, if the sheet-like material, according to a modification of the invention, is structured and/or transparent. The optical and tactile characteristics of the work piece surface can be configured more varied and appealing on this account.

Instead of using an already structured film, it is also possible, according to a modification of the present invention, that the device also has a structure formation unit to form a structure on the sheet-like material, which is preferably arranged upstream of the printing unit. By providing a structure formation unit, the number of variants of the device according to the invention can be further increased, since structured and unstructured surface areas can be combined with each other even on a single work piece. Provision of the structure formation upstream of the printing unit makes it possible for the printed image applied by the printing unit not to be damaged by the structure formation unit.

According to a modification of the present invention, it is also prescribed that the device according to the invention also have a structure sensing unit to detect a structure on the sheet-like material, which is preferably arranged upstream of the printing unit. The printed image to be applied by the printing unit can therefore be optimally adjusted to the structure present on the sheet-like material, so that the appearance and quality and durability can be further increased.

According to another objective of the invention, it is proposed that the device also have a control unit, which is connected to the printing unit, and in which image data for the pattern to be applied to the sheet-like material are stored. The control unit makes it possible to switch between different patterns and/or structurings during operation of the device and to further increase the variability of the device. It is then particularly preferred that data concerning the type and positioning of a structuring of a sheet-like material are also available in the control device, so that optimal adjustment between image data and structure data, and therefore an optimal appearance, can be achieved.

The data concerning the type and positioning of structuring of the sheet-like material can be made available by the fact that the control unit is connected to the structure formation unit and/or the structure sensing unit. Because of this, an adjustment between the image data and structure data can be carried out at the latest possible time with a corresponding increase in variability and versatility of the device according to the invention.

Although the sheet-like material need not necessarily be firmly applied to the work pieces, it is proposed according to a modification of the invention that the device also have an adhesive application unit to apply an adhesive to the sheet-like material and/or the work piece. Any preparatory work for firm joining between the sheet-like material and the work pieces is eliminated on this account, so that a rapid operation free of disturbances is made possible.

The device according to the invention can be used in the context of the present invention in a wide variety of machine concepts. According to a modification of the present invention, it is proposed, for example, that the device be designed as a continuous machine, in which the work pieces are continuously or at least quasi-continuously moved through the device (i.e., the panel-like work piece can be stopped temporarily during passage). It is also conceivable that the device could be designed as a machining center, in which the work pieces are firmly tightened on a clamping table, in which case the clamping table itself can be arranged stationary, or also movable within limits.

Especially for the area of machining centers, it is preferred according to a modification of the present invention that the device is designed at least partially as a unit insertable into a spindle unit, which preferably has a connection opening operationally connectable to a spindle unit. The variability of the machining center is increased substantially on this account, since a machining center is made possible that initially executes different machining steps of a work piece (for example, cutting) before the aforementioned unit is introduced to the spindle unit and imparting of a pattern onto the surface of the work piece is carried out. The unit to be inserted into a spindle unit can then have one or more components that are chosen from the printing unit, sheet feed unit, application unit, sheet supply unit, structure formation unit, structure sensing unit and adhesive application unit.

According to another objective, the present invention provides a method for imparting a pattern onto the surface of work pieces, using a device according to Claim 17 according to the invention. This method permits economical and rapid operation of the device according to the invention.

### BRIEF DESCRIPTION OF THE DRAWING

FIG. 1 schematically shows a top view of a pattern-imparting device 1 as a preferred embodiment of the present invention.

### DETAILED DESCRIPTION OF PREFERRED EMBODIMENTS

Preferred embodiments of the present invention are described at length below with reference to the accompanying drawings.

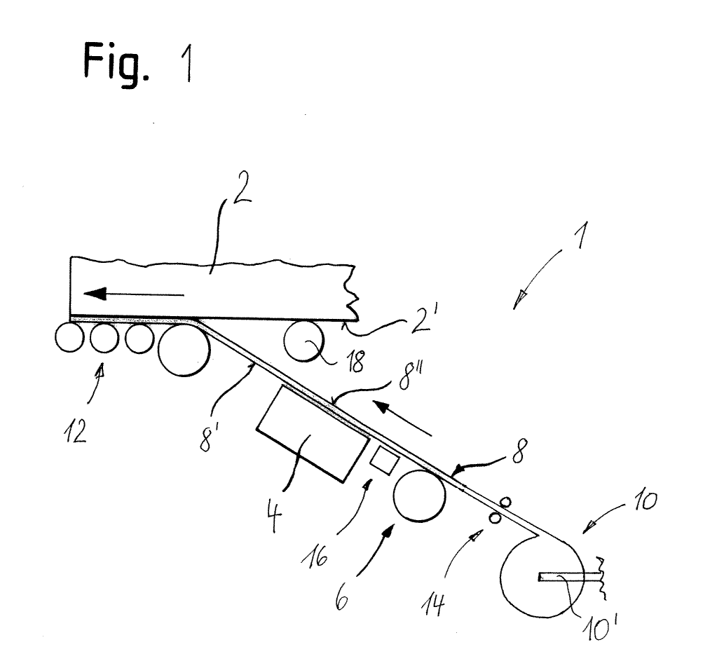

FIG. 1 schematically depicts a pattern-imparting device 1 as a preferred embodiment of the present invention. The device 1 is used to impart a pattern onto the surface of work pieces that consist at least partially of wood, wood materials, plastics or the like, although the present invention is not restricted to them. The work pieces, for example, can be panel-like work pieces, as frequently used in the furniture industry, but also strip-like or extruded sections. The work pieces, in the context of the present invention, can also have a sharply varying geometry, like free-form panels, elongated sections with a free-form cross-section, three-dimensionally curved work pieces, etc. The case of a panel-like work piece 2 is depicted in FIG. 1, which is to be given a pattern in the area of a narrow surface 2′. However, it is also conceivable to impart a pattern onto the work pieces over a large area, and specifically on curved, uniform or other surfaces.

The pattern-imparting device 1 initially includes a printing unit 4, which is designed in the present practical example as an inkjet printing unit. The printing unit 4 therefore has a number of nozzle outlet openings, from which ink drops be ejected in reaction to control signals, using appropriate elements, like piezo- or thermoelements, the control signals being provided from a control unit, not further shown here.

Pattern-imparting device 1 also includes a sheet feed unit 6 to feed a sheet-like material 8 along printing unit 4. The sheet feed unit 6 is then configured, so that it feeds the sheet-like material at a specified distance along printing unit 4, which is suitable for the printing operation of printing unit 4. The sheet feed unit 6, for example, can have a number of feed and guide rolls, only one or which is shown in FIG. 1.

The pattern-imparting device 1 also includes a sheet supply unit 10 for continuous supply of the sheet-like material 8 to the sheet feed unit 6. In the present embodiment, the sheet supply unit 10 is formed by a receptacle 10′, on which a spool with sheet-like material 8 is mounted to rotate.

It should be noted overall that the sheet-like material, in the context of the present invention, can be configured in a wide variety of ways, for example, as a narrow strip, as is often used in the area of edges, and also as a wide strip for large-area patterns. The sheet-like material can also be used as an endless material or as several sheet sections that can be page-like. The sheet-like material can also have one or more layers. The sheet-like material or its layers can then consist of a wide variety of materials, for example, paper, plastic, plastic film, aluminum, aluminum foil, wood and wood veneer, etc., although the present invention is not restricted to them.

The pattern-imparting device 1 also includes an application unit 12 to apply the sheet-like material 8 to surface 2′ of the corresponding work piece. In the present embodiment, the application unit 12 is formed by a number of pressure rolls, which can also be freely rotatable or partially driven.

Although not explicitly shown in FIG. 1, the pattern-imparting device according to the invention also has a conveyor device set up to convey the corresponding work pieces along the application unit. The conveyor device in the present embodiment can therefore be a belt, chain or other conveyor, so that the device overall can be a continuous device.

In an alternative embodiment of the present invention, however, it is also possible that the work piece 2 need not necessarily be moved, but the pattern-imparting device 1 partially driven or driven as a whole, for example, during use of a pattern-imparting device in a machining center. Although it is also not shown in the figure, it is particularly apparent in this case that the pattern-imparting device can be formed at least partially as a unit insertable into a spindle unit, which has a connection section, connectable operationally to a spindle unit. Via this connection section, which can also be referred to as a universal interface, rotary drive and control signals, but optionally also printing fluid or the like, can be transferred from the spindle unit to the pattern-imparting device.

The printing unit in FIG. 1 is arranged, so that the side 8′ of the sheet-like material facing away from work piece 2 is printed. In the context of the present invention, however, it is also possible that the printing unit is arranged on the opposite side, i.e., on the side 8″ of the sheet-like material facing the work piece 2, in order to print this side 8″.

As is also apparent in FIG. 1, the pattern-imparting device 1 in the present embodiment also includes a structure formation unit 14 to form a structure on the sheet-like material 8, which is arranged upstream of the printing unit 4. The structure formation unit 14, for example, can be a structured roll, a structured plate or the like. A structure sensing unit 16 to detect a structure on the sheet-like material 8 can also be arranged between the structure formation unit 14 and the printing unit 4. The structure sensing unit, for example, can be a unit based on optical or ultrasonic principles.

The printing unit 4, the structure formation unit 14 and the structure sensing unit 16 in the present variant are connected to a control device (not further shown), for example, in the form of a control computer. Image data for the pattern to be applied to the sheet-like material 8 are stored in the control computer, which can be automatically selected and sent to the printing unit 4 or input by a user. Selection of the image data can also occur with consideration of data that the control unit obtains from the structure formation unit 14 or the structure sensing unit 16, in order to adjust the image data optimally to the structure data.

Finally, the pattern-imparting device 1 includes an adhesion application unit 18 in the form of an adhesive application roll. Although the adhesive application roll 18 is arranged in FIG. 1 in order to apply an adhesive to the surface 2′ of work piece 2, it can also be arranged in order to apply the adhesive directly to the sheet-like material 8 or to both surfaces.

Operation of the pattern-imparting device 1 according to the invention occurs as follows. During transport of a panel-like work piece along the conveyor device, the sheet-like material 8 is unwound from the sheet supply unit 10 and guided by the sheet feed unit 6 along the printing unit 4. The sheet-like material 8, based on the image data entered in the control unit, optionally with consideration of the structure data of the sheet-like material 8, is then printed. The sheet-like material then reaches the application unit 12, where it is applied and pressed onto the surface 2′ of the corresponding work piece 2 being printed. If an adhesive was applied, the sheet-like material 8 permanently remains on work piece 2. As explained above, however, it is also possible to use the sheet-like material 8 merely as a transfer medium and, after pressing onto the work piece 2, remove it from work piece 2 after successful transfer of the printed image. The sheet-like material can then also advantageous be used as a protective film during transport.

1. A device for imparting a pattern onto the surface of wood or plastic containing work pieces, comprising:
a printing unit,
a sheet feed unit to feed a sheet-like material along the printing unit, so that the sheet-like material can be printed by the printing unit,
a sheet supply unit to continuously supply the sheet-like material through the sheet feed unit,
an application unit to apply the printed sheet-like material to the surface of the corresponding work piece, and
a conveyor device, set up to produce a relative movement between the corresponding work pieces and at least the application unit.

2. A device according to claim 1, wherein the printing unit is arranged so that the side of the sheet-like material facing away from the work piece is printed.

3. A device according to claim 1, wherein the printing unit is arranged so that the side of the sheet-like material facing the work piece is printed.

4. A device according to claim 1, wherein the printing unit is an inkjet printing unit or a rotary printing unit.

5. A device according to claim 1, wherein the sheet supply unit has a receptacle for a supply of sheet-like material, which contains a supply of sheet-like material.

6. A device according to claim 5, wherein the sheet-like material has one or more layers.

7. A device according to claim 5, wherein the sheet-like material is structured and/or transparent.

8. A device according to claim 1, wherein the device also has a structure formation to form a structure on the sheet-like material, which is arranged upstream of the printing unit.

9. A device according to claim 1, wherein the device also has a structure sensing unit to detect a structure on the sheet-like material, which is arranged upstream of the printing unit.

10. A device according to claim 1, wherein the device also has a control unit, which is connected to the printing unit, and in which the image data for the powder to be applied to the sheet-like material are stored.

11. A device according to claim 10, wherein data concerning the type and positioning of structuring of the sheet-like material are also available in the control unit.

12. A device according to claim 11, wherein the control unit is connected to the structure formation unit and/or the structure formation unit.

13. A device according to claim 1, wherein the device also has an adhesion application unit to apply an adhesive to the sheet-like material and/or the work pieces.

14. A device according to claim 1, wherein the device is designed as a continuous machine or machining center.

15. A device according to claim 1, wherein the device is designed at least partially as a unit insertable into a spindle unit, which has a connection section, operationally connectable to a spindle unit.

16. A device according to claim 15, wherein the components of the insertable unit are chosen from printing unit, sheet feed unit, application unit, sheet supply unit, structure formation unit, structure sensing unit and adhesive application unit.

17. A method for imparting a pattern onto the surface of wood or plastic containing work pieces, comprising, using a device according to claim 1, further comprising:
feeding of a sheet-like material by means of sheet feed unit along printing unit,
printing of the sheet-like material by means of printing unit,
applying the sheet-like material to work piece by means of application unit during a relative movement between work piece and application unit.
